(19) United States
(12) Patent Application Publication
(10) Pub. No.: US 2009/0164241 A1
(43) Pub. Date: Jun. 25, 2009

(54) METHOD AND SYSTEM FOR OPTIMIZING PRIMARY AND EMERGENCY HEALTH CARE TREATMENT

(76) Inventors: Vincent C. Racioppo, Highland Park, IL (US); John E. Whitcomb, Elm Grove, WI (US); Philip F. Troiano, Milwaukee, WI (US)

Correspondence Address: JOSEPH S. HEINO, ESQ.;DAVIS & KUELTHAU, S.C., 111 E. KILBOURN, SUITE 1400, MILWAUKEE, WI, 53202-6613, US

(21) Appl. No.: 12/338,856

(22) Filed: Dec. 18, 2008

Related U.S. Application Data
(60) Provisional application No. 61/014,527, filed on Dec. 18, 2007.

(51) Int. Cl. G06Q 50/00; G06Q 10/00

(52) U.S. Cl. 705/2; 705/7; 705/11

(57) ABSTRACT

A four-phase emergency room triage program comprises phases identified as “Assessment;” “Alignment;” “Application;” and “Auditing.” Under the “Assessment” phase, a hospital uses a tool to allow the hospital to fully understand how and whether the present invention should be utilized by it. During the Alignment phase, a step-by-step framework and an “Audit and Quality Checklist” is implemented. The Application phase requires that a physician readiness workshop be conducted to restructure the strategies and thinking of physicians in the method and system, thus providing tools and language that assures success. During this phase, various objectives are accomplished including guiding physicians and staff through numerous consultations and demonstrations to develop new language and behaviors and assuring that all aspects of implementation are successful by reviewing the Checklist. The “Auditing” phase utilizes the Checklist to assure that the healthcare organization is achieving desired results.

This application claims the benefit and priority of U.S. Provisional Patent Application No. 61/014,527 filed Dec. 18, 2007.

### FIELD OF THE INVENTION

The present invention relates generally to methods and systems that are used in the area of health care treatment and the administration of health care treatment. It also relates generally to computer implementation of such methods and systems. More particularly, it relates to a method and system for optimizing primary and emergency health care treatment. It also relates to such a method where the most effective and the best care possible is provided using the core competencies of emergency department triage reform, process change, expert performance, care plan management and emergency department auditing.

### BACKGROUND OF THE INVENTION

In the field of healthcare, and particularly in the field of medical emergency treatment, there has existed, and there continues to exist, a perception that private health care facilities have denied and continue to deny certain individuals emergency care for purely economic reasons, i.e. that the individuals are indigent or uninsured and that the private health care facility and its staff will not be paid for services provided to such individuals. Partly in response to this perception, and for other reasons not germane to this application, Congress enacted the Emergency Medical Treatment and Active Labor Act (EMTALA). EMTALA is considered to be Congress' solution to the lack of access to health care for the indigent and the uninsured.

One result of EMTALA is that it has defined a standard of care to be applied to the rendering of hospital emergency services. In effect, it created an unprecedented federal right to emergency health care. Subsequent amendments by Congress have made the scope of EMTALA so expansive as to govern most every aspect of a hospital's delivery of emergency health care services. As a practical matter, this includes not only emergency physicians, but all medical staff who take call for the emergency department, including any medical staff who admit patients to the hospital and any who discharge them. Court decisions and dicta have also made it clear that, by applying the provisions of EMTALA, a hospital can be sued directly, and not just vicariously, for damages that a patient sustains as a result of a physician's negligent violation of EMTALA's provisions. Under EMTALA, the narrow view that a hospital is a place where physicians practice medicine has been replaced by the more expansive view that it is in fact the hospitals themselves that “practice” medicine. Simply put, hospitals are now directly responsible for the actions of all members of their medical staffs, which includes the concomitant duty to control all medical staff members and particularly those who my not be willing to provide on-call services or accept patients who show up at the hospital's emergency room for treatment.

The reality of practicing medicine in the emergency department realm versus private office practice is that, in a private office practice, the treating physician makes agreements and contracts with his or her patients for compliance, follow-up and care. As compared to emergency department treatment, private practice treatment has much more control over its own resources as well as any reimbursement issues that may be avoided. In the case of emergency department treatment, there tends to be multiple partners involved in such treatment, each with variable tolerance to issues of compliance, self-care, and so on. To make matters worse, many of the patients, but not all of them, who come to an emergency department for treatment are lonely, are disposed to having to undergo tests (such as in the case of persons suffering from Munchausen's disease), are violent or threatening, are complaining and litigious, or simply have been sent from a private practice office to the emergency department because they have effectively burned their bridges with other treating doctors in private practice. All of this results in unpredictable, repetitive and financially unstable treatment options for such patients. Other reasons that patients tend to over-use emergency department facilities are that emergency medical physicians are typically perceived to have higher quality by virtue of doing more tests to determine what may or may not be wrong with the patient and that the same physicians prescribe more medications without full disclosure of patient histories. Additionally, the hours that an emergency room is available tends to be more convenient for working families with multiple jobs. Accordingly, there is an element of familiarity and a perception of higher quality in many of today's emergency department facilities. That is there is a learned pattern of conduct in many repetitive users that simply draws them back to such facilities. Many such patients may have been actually born in the particular facility and come there for all illnesses, serious or otherwise. Others simply don't know the way to any other facility or health care professional. By over-using the emergency department facility, the patient feels familiar with the surroundings, including the waiting room, which is treated by the patient essentially as the waiting room of a private practice office. In point of fact, research is available to these inventors suggesting that upwards of seventy-five percent (75%) of emergency department patients could have been treated elsewhere. In short, many emergency treatment facilities view themselves as society's “safety net” where they feel obligated to see and treat everyone. Such a view of emergency room utilization is not, however, conducive to the most economic way for an emergency department to operate and may, in fact, compromise the level of care provided to patients, which patients may well be treated more consistently and economically by utilization of private practice offices.

In the view of these inventors, each of whom is either an experienced and seasoned emergency department physician and/or administrator, there has long been the need for a method and a system whereby hospitals and health care professionals alike can take a systematic approach to this changed landscape in the area of emergency room health care treatment. Such a method and system would provide patients with consistent care, such care being provided on an economical basis. Such a method and system would also provide hospitals with some degree of certainty that their actions, and those of their staff, comply with EMTALA when delivering hospital-based emergency health care services.

The primary focus of such a method and system is to create community-wide solutions for optimizing primary and emergency treatment through emergency department triage reform, process change, expert performance, care plan management and emergency department auditing. The method and system of the present invention uses these core competencies to always seek the most effective and best care possible. This method and system can be summarized as “right care, right time, right place, right price.” In short, the method and system disclosed here has, as a primary objective, the goal of improving the way that America does healthcare, and each of the aforementioned aspects is a further object of the present invention. Another object of the present invention is to increase collaboration and information sharing between and within healthcare organizations, thus targeting the goals of creating an enhanced level of cooperation and collegiality between emergency department professionals, reducing the percentage of non-emergent patients within an emergency department and increasing overall savings per patient.

### SUMMARY OF THE INVENTION

The present invention has obtained these objects. It provides for a method and system that may be computer implemented to improve the way America does health care. The method and system of the present invention creates community-wide solutions for current health care access challenges. The primary focus is to create community-wide solutions to optimize primary and emergency treatment by seeking the most effective and best care possible. More specifically, the method and system of the present invention includes emergency department triage reform.

The method and system of the present invention is novel in that it has been proven by these inventors to successfully reduce primary care patient emergency department use by crafting a risk free and highly effective triage reform. The method and system is implemented using methodologies that are practiced by medical professionals who work on site with potential clients and that focus on expert performance. Such expert performance, in part, addresses specifically how the best emergency department physicians communicate with and educate patients in the community. Further, the method and system of the present invention is strategic and addresses systemic and root causes of inappropriate healthcare use. It produces creative solutions that, once implemented, continue to address the serious drains on healthcare financing.

In the experience of the present inventors, and depending upon the level of commitment to the complete adoption of the methodology, users of the method and system of the present invention benefit in a number of tangible ways. There is typically an improvement of emergency department financial performance and overall hospital financial improvement. There may be increased medical staff and customer patient satisfaction. There most usually is an improvement in patient care outcomes and faster access for acutely ill patients. There is typically increased data sharing regarding emergency department “hyper users.” Moreover, all of this reform is realized without risk of EMTALA citations.

Specifically, the business method and system of the present invention is a four-phase program for properly dealing with emergency room triage. Generally, the phases are identified as follows:

Phase One—“Assessment” phase

Phase Two—“Alignment” phase

Phase Three—“Application” phase

Phase Four—“Auditing” phase

Under the “Assessment” phase of the method and system of the present invention, a hospital uses a tool that is called the “Readiness Assessment.” This tool is used to allow the hospital to fully understand how likely it will be to reduce costs, to reduce census and to improve care by using the method and system of the present invention. The tool fully examines nine (9) crucial areas, provides a clear readiness picture, and provides suggestions to remedy challenging issues. A review of the Readiness Assessment results determines how and if the business method and system of the present invention should be utilized.

The next portion of the business method and system of the present invention is the “Alignment” phase. During this Alignment phase, a step-by-step framework is implemented. During this phase, the hospital will be assisted in having its medical staff learn, among other things, how and when to refer patients to other destinations and fully understand the boundaries and implement compliance requirements of EMTALA. Additionally, an “Audit and Quality Checklist” is used to assure that the medical staff is successful in this phase, which assures quick results as well as sustainable success.

The “Application” phase of the business method and system of the present invention, requires that a physician readiness workshop be conducted to restructure the strategies and thinking of physicians in the method and system, thus providing tools and language that assures everyone's success. During this phase, various objectives are accomplished including guiding physicians and staff through numerous consultations and demonstrations to develop new language and behaviors and assuring that all aspects of implementation are successful by reviewing the “Audit and Quality Checklist” mentioned above.

The final phase, the “Auditing” phase of the business method and system of the present invention utilizes the Audit and Quality Checklist to assure that the healthcare organization is achieving the results wanted. The foregoing and other features of the method and system of the present invention will become apparent from the detailed description that follows.

### BRIEF DESCRIPTION OF THE DRAWINGS

FIG. 1 is a schematic representation of the overall flow of the method and system of the present invention which is a four-phase program for properly dealing with emergency room triage.

FIG. 2 is a schematic representation of the “Assessment” phase of the method and system of the present invention.

FIG. 3 is a schematic representation of the “Alignment” phase of the method and system of the present invention.

FIG. 4 is a schematic representation of the “Application” phase of the method and system of the present invention.

FIG. 5 is a schematic representation of the “Auditing” phase of the method and system of the present invention.

### DETAILED DESCRIPTION

It is to be understood that the method and system of the present invention may be implemented in hardware and/or software, preferably in computer programs executing on a programmable computer having a processor, a data storage system, at least one input device and at least one output device. Program code and algorithms are applied to input data to transform the data and perform the functions described herein, all for the purpose of generating useful output information in accordance with the method and system of the present invention. The output information is applied to one or more output devices, in known fashion. The program code is preferably implemented in a high level procedural or object oriented programming language in accordance with a program to communicate with a computer system. The program is preferably stored on a storage media or device (e.g. ROM or magnetic diskette) readable by a general or special purpose programmable computer, for configuring and operating the computer when the storage media or device is read by the computer to perform the procedures described herein. The inventive system may also be considered to be implemented as a computer-readable storage medium, configured with a computer program, where the storage medium so configured causes a computer to operate in a specific and predefined manner to perform the functions described herein and to transform the inputted data via operative algorithms into meaningful output information.

As previously mentioned, the present invention provides for a method and system that may be computer implemented to improve the way America does health care. The method and system of the present invention creates community-wide solutions for current health care access challenges. The primary focus is to create community-wide solutions to optimize primary and emergency treatment by seeking the most effective and best care possible. The method and system of the present invention also specifically includes emergency department triage reform.

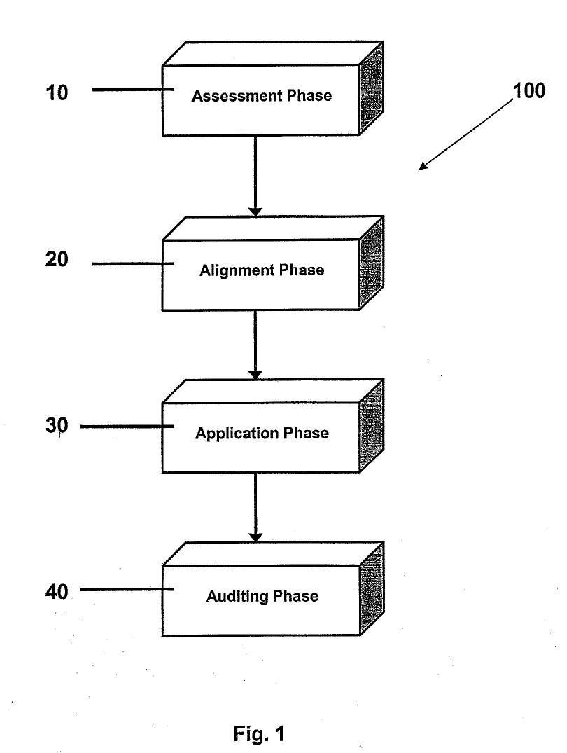

With reference now to the drawings, wherein like numbers represent like elements throughout, FIG. 1 is a schematic representation of the overall flow of the method and system, generally identified 100, of the present invention which is a four-phase program for properly dealing with emergency room triage. In this detailed description, the healthcare organization that uses the method and system 100 will be referred to herein as the “user.” As previously mentioned, the specific phases of the method and system 100 are the “Assessment” phase 10; the “Alignment” phase 20; the “Application” phase 30; and the “Auditing” phase 40.

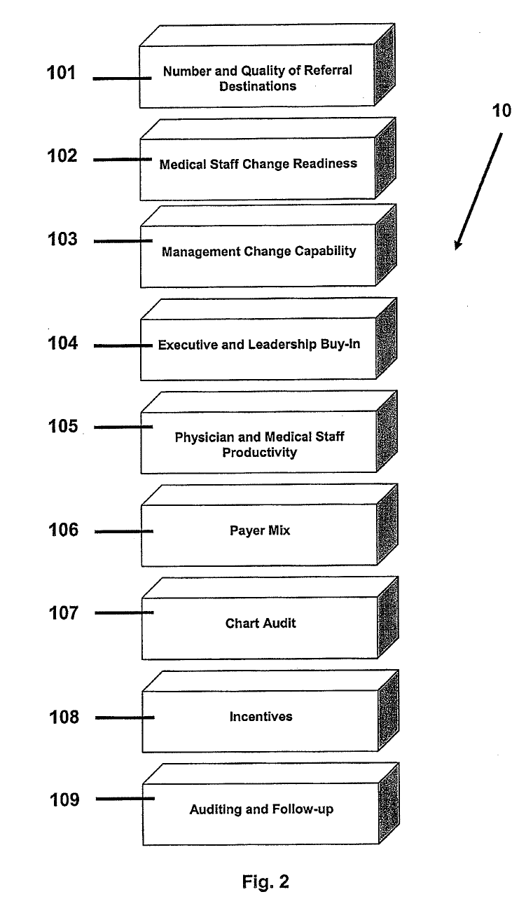

Under the “Assessment” phase 10 of the method and system 100 of the present invention, a tool that is called the “Readiness Assessment” is used. See FIG. 2. This tool literally “assesses” the “readiness” of the user and allows the user to understand and feel comfortable with its probability for success, specifically allowing the user to fully understand how likely it will be to reduce costs, to reduce census and to improve care by using the method and system of the present invention. The tool fully examines nine (9) crucial areas, provides a clear readiness picture, and provides suggestions to remedy challenging issues. A review of the Readiness Assessment results determines how and if the business method and system of the present invention should be utilized. During this Readiness Assessment, the following items of information are examined:
(i) number and quality of referral destinations 101
(ii) medical staff change readiness 102
(iii) management change capability (for both physicians and medical staff) 103
(iv) executive and leadership buy-in 104
(v) physician and medical staff productivity 105
(vi) payer mix 106
(vii) chart audit 107

(viii) incentives 108
(ix) auditing and follow-up 109

During the Assessment Phase 10, various of the user's business officers and directors are interviewed and asked questions that are pertinent to the Readiness Assessment 10. Such individuals may include one or more of the user's chief executive officer (CEO), chief financial officer (CFO), chief operating officer (COO), vice-president of nursing, the emergency department medical director, the emergency department director, the emergency department manager, the emergency department physicians, the community health center director, the public relations director, the emergency department mid-level staff, the emergency department nursing staff, the risk management director, the chief of medical staff, and primary care providers who are willing to see, or who currently see, Medicaid patients. The general areas of inquiry for these persons are in the areas of community, financial, patient care, internal processes, destinations, audits, change readiness and leadership. Specific questions might include who are the formal and informal emergency department leaders and are they supportive? What has the user's experience been with programs requiring significant change? What was the nature of the most recent successful change initiative and what were its success features? Everyone has had projects that failed, but what characteristics of any failed projects should we avoid?

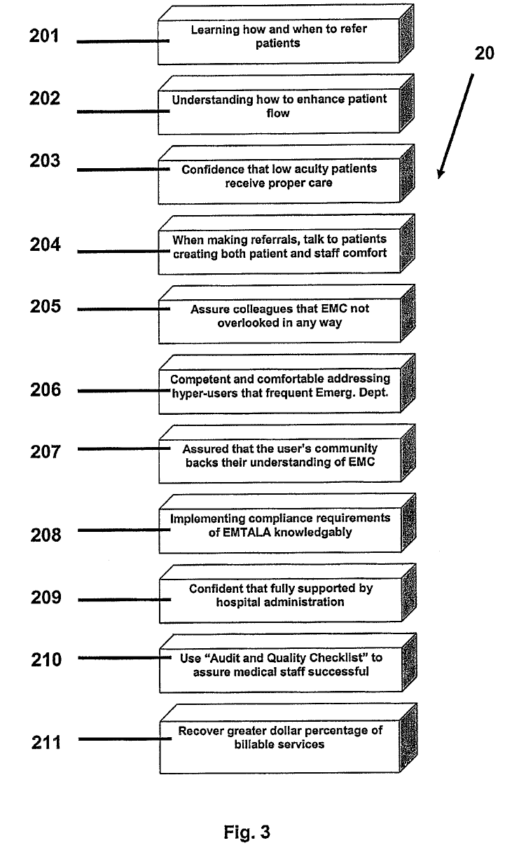

Assuming that there is a positive outcome during the Assessment Phase 10, the next phase of the business method and system 100 of the present invention is the “Alignment” phase 20. See FIG. 3. During this Alignment phase 20, a step-by-step framework is implemented. During this phase 20, the user is assisted to help its medical staff to do the following steps:
(a) learning how and when to refer patients to other destinations 201
(b) understanding how to enhance patient flow through the emergency department so that medical staff resources can be used even more effectively than they already are 202
(c) feeling confident that low acuity patients will receive proper care when referred to appropriate destinations 203
(d) learning how, when making such referrals, to talk to patients in ways that create comfort for both the patient and the staff 204
(e) assuring themselves and their colleagues that Emergency Medical Conditions (EMC) are not overlooked in any way
(f) feeling competent and comfortable addressing hyper-users and those who create conditions that sustain their frequent emergency department use 206
(g) feeling assured that the user's community backs their understanding of what is and what is not an EMC 207
(h) fully understanding the boundaries and implementing compliance requirements of EMTALA and any other applicable state or federal legislation 208
(i) feeling confident that they are fully supported by hospital administration through incentives and the like 209
(j) using an “Audit and Quality Checklist” to assure that medical staff are successful 210 (which assures quick results as well as sustainable success; furthermore, it allows the user to quickly assess effectiveness and to provide detailed reports on each referring staff member, thus identifying the most successful staff and coach those who are challenged)
(k) recovering a greater dollar percentage of billable services 211

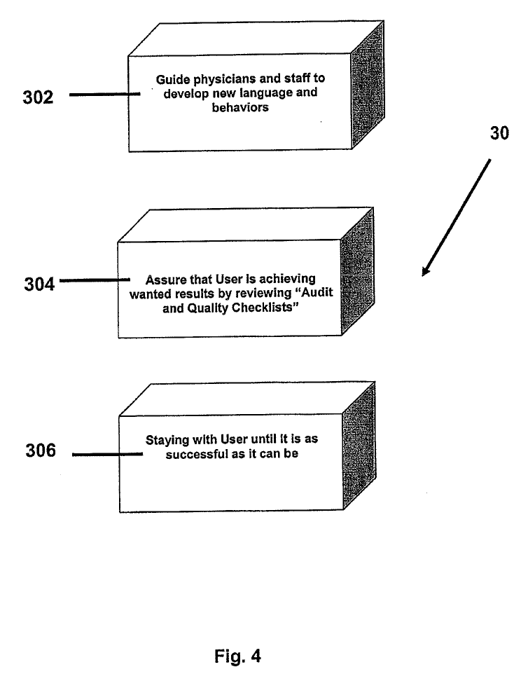

Following a successful Alignment phase 20, the “Application” phase 30 of the business method and system 100 of the present invention is implemented. See FIG. 4. The Application phase 30 requires that a physician readiness workshop be conducted to restructure the strategies and thinking of the user's physicians, thus providing tools and language that assures everyone's success. During this phase 30, the following objectives are accomplished:
(a) guide physicians and staff through numerous consultations and demonstrations to develop new language and behaviors 302
(b) assure that all aspects of implementation are successful by reviewing “Audit and Quality Checklists” to assure that the user is achieving the results wanted 304
(c) staying with the user until it is as successful as it can be 306

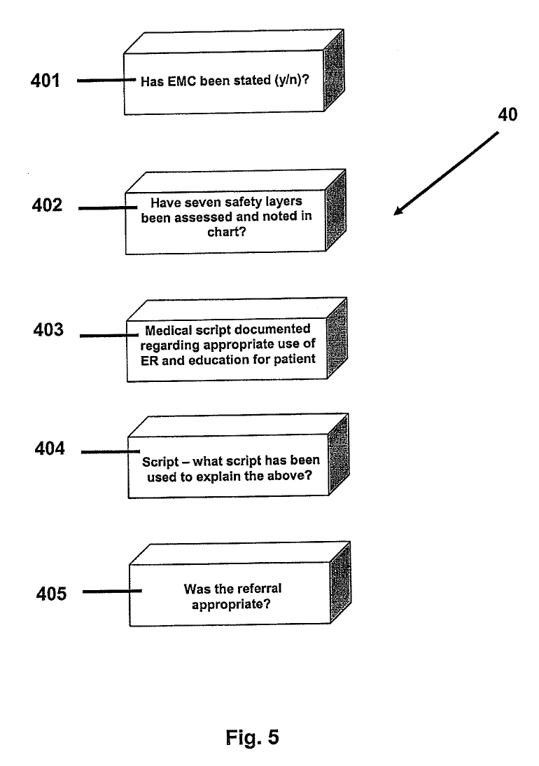

The final phase, the “Auditing” phase 40 of the method and system 100 of the present invention utilizes the following Audit Checklist, as is shown in FIG. 5:
(a) has an Emergency Medical Condition (EMC) been stated (y/n)? 401
(b) have the following seven layers of safety been assessed and have these been noted in the chart? 402
   i. minor complaint
   ii. normal vital signs
   iii. nursing triage to low level of acuity.
   iv. no exclusion classes like immuno-suppressed, severe pain, age over 70, less than 6 months, etc.
   V. normal history and physical (i.e. no patient “red flags”)
   vi. clinical judgment of medical team
   vii. a medical home and do they have access in time before the condition deteriorates into an EMC
(c) If no EMC, medical script documented regarding appropriate use of ER and education for patient? 403
(d) Script—what script has been used to explain the above? 404
(e) Was the referral appropriate? 405 (i.e., no EMC based on criteria above)

To continue the successful use of the method and system 100 of the present invention, charts using the “Audit and Quality Checklist” (mentioned earlier as part of Phase Two—Alignment 20) are also audited regularly as part of the Audit phase 40 to assure that success is sustained. Detailed reporting is provided on each referring staff member so that performance is assured. A user “facilitator” intervenes as needed and as appropriate to assure itself of the greatest likelihood of continued high performance. Finally, the facilitator is available for consultations, on an “as needed” basis, and continues to meet with the user until it is achieving the success that it desires or requires.

In view of the foregoing, it will be seen that the primary-focus of the method and system 100 of the present invention is to create community-wide solutions to optimize primary and emergency treatment by seeking the most effective and best care possible. More specifically, the applicants have devised a business method and system model that includes emergency department triage reform.

The details of the invention having been disclosed in accordance with the foregoing, we claim:

1. A method for optimizing primary and emergency health care treatment comprising the steps of
providing an assessment phase;
providing an alignment phase;
providing an application phase; and
providing an auditing phase.

2. The method of claim 1 wherein the assessment phase providing step comprises the step of using a readiness assessment tool wherein the user's readiness for use of the method is assessed and wherein the user is allowed to understand its probability for success and how likely it will be to reduce costs, reduce census and improve patient care.

3. The method of claim 2 wherein the readiness assessment tool allows the user to examine one or more items of information selected from a group consisting of
the number and quality of referral destinations;
medical staff change readiness;
management change capability for both physicians and medical staff;
executive and leadership buy-in;
physician and medical staff productivity;
payer mix;
chart audit;
incentives;
auditing; and
follow-up.

4. The method of claim 1 wherein the alignment phase providing step comprises one or more steps from a group consisting of
learning how and when to refer patients to other destinations;
understanding how to enhance patient flow through the emergency department so that medical staff resources can be used even more effectively than they already are;
feeling confident that low acuity patients will receive proper care when referred to appropriate destinations;
learning how to talk to patients in ways that create comfort for both the patient and the staff when making such referrals;
assuring themselves and their colleagues that emergency medical conditions are not overlooked;
feeling competent and comfortable addressing hyper-users and those who create conditions that sustain their frequent emergency department use;
feeling assured that the user's community backs their understanding of what is and what is not an emergency medical condition;
fully understanding the boundaries and implementing compliance requirements of the Emergency Medical Treatment and Active Labor Act;
feeling confident that they are fully supported by hospital administration through incentives and the like;
using an audit and quality checklist to assure that medical staff are successful in implementing the method; and
recovering a greater dollar percentage of billable services.

5. The method of claim 1 wherein the application phase providing step comprises the step of conducting a physician readiness workshop to restructure the strategies and thinking of the user's physicians.

6. The method of claim 1 wherein the auditing phase providing step comprises the step of utilizing an audit checklist to assure that successful implementation of the method of the present invention is accomplished.

7. A computer implemented method for optimizing primary and emergency health care treatment comprising the steps of
providing an assessment phase;
providing an alignment phase;
providing an application phase; and
providing an auditing phase.

8. The computer implemented method of claim 7 wherein the assessment phase providing step comprises the step of using a readiness assessment tool wherein the user's readiness for use of the method is assessed and wherein the user is allowed to understand its probability for success and how likely it will be to reduce costs, reduce census and improve patient care.

9. The computer implemented method of claim 8 wherein the readiness assessment tool allows the user to examine one or more items of information selected from a group consisting of
the number and quality of referral destinations;
medical staff change readiness;
management change capability for both physicians and medical staff;
executive and leadership buy-in;
physician and medical staff productivity;
payer mix;
chart audit;
incentives;
auditing; and
follow-up.

10. The computer implemented method of claim 7 wherein the alignment phase providing step comprises one or more steps from a group consisting of
learning how and when to refer patients to other destinations;
understanding how to enhance patient flow through the emergency department so that medical staff resources can be used even more effectively than they already are;
feeling confident that low acuity patients will receive proper care when referred to appropriate destinations;
learning how to talk to patients in ways that create comfort for both the patient and the staff when making such referrals;
assuring themselves and their colleagues that emergency medical conditions are not overlooked;
feeling competent and comfortable addressing hyper-users and those who create conditions that sustain their frequent emergency department use;
feeling assured that the user's community backs their understanding of what is and what is not an emergency medical condition;
fully understanding the boundaries and implementing compliance requirements of the Emergency Medical Treatment and Active Labor Act;
feeling confident that they are fully supported by hospital administration through incentives and the like;
using an audit and quality checklist to assure that medical staff are successful in implementing the method; and
recovering a greater dollar percentage of billable services.

11. The computer implemented method of claim 7 wherein the application phase providing step comprises the step of conducting a physician readiness workshop to restructure the strategies and thinking of the user's physicians.

12. The computer implemented method of claim 7 wherein the auditing phase providing step comprises the step of utilizing an audit checklist to assure that successful implementation of the method of the present invention is accomplished.

13. A system for optimizing primary and emergency health care treatment comprising
means for providing an assessment phase;
means for providing an alignment phase;
means for providing an application phase; and
means for providing an auditing phase.

14. The system of claim 13 wherein the assessment phase providing means comprises means of using a readiness assessment tool wherein the user's readiness for use of the system is assessed and wherein the user is allowed to understand its probability for success and how likely it will be to reduce costs, reduce census and improve patient care.

15. The system of claim 14 wherein the readiness assessment tool allows the user to examine one or more items of information selected from a group consisting of
the number and quality of referral destinations;
medical staff change readiness;
management change capability for both physicians and medical staff;
executive and leadership buy-in;
physician and medical staff productivity;
payer mix;
chart audit;
incentives;
auditing; and
follow-up.

16. The system of claim 13 wherein the alignment phase providing means comprises one or more from a group consisting of
learning how and when to refer patients to other destinations;
understanding how to enhance patient flow through the emergency department so that medical staff resources can be used even more effectively than they already are;
feeling confident that low acuity patients will receive proper care when referred to appropriate destinations;
learning how to talk to patients in ways that create comfort for both the patient and the staff when making such referrals;
assuring themselves and their colleagues that emergency medical conditions are not overlooked;
feeling competent and comfortable addressing hyper-users and those who create conditions that sustain their frequent emergency department use;
feeling assured that the user's community backs their understanding of what is and what is not an emergency medical condition;
fully understanding the boundaries and implementing compliance requirements of the Emergency Medical Treatment and Active Labor Act;
feeling confident that they are fully supported by hospital administration through incentives and the like;
using an audit and quality checklist to assure that medical staff are successful in implementing the method; and
recovering a greater dollar percentage of billable services.

17. The system of claim 13 wherein the application phase providing means comprises means for conducting a physician readiness workshop to restructure the strategies and thinking of the user's physicians.

18. The system of claim 13 wherein the auditing phase providing means comprises means for utilizing an audit checklist to assure that successful implementation of the system of the present invention is accomplished.

19. A computer implemented system for optimizing primary and emergency health care treatment comprising
means for providing an assessment phase;
means for providing an alignment phase;
means for providing an application phase; and
means for providing an auditing phase.

20. The computer implemented system of claim 19 wherein the assessment phase providing means comprises using a readiness assessment tool wherein the user's readiness for use of the system is assessed and wherein the user is allowed to understand its probability for success and how likely it will be to reduce costs, reduce census and improve patient care.

21. The computer implemented system of claim 20 wherein the readiness assessment tool allows the user to examine one or more items of information selected from a group consisting of
the number and quality of referral destinations;
medical staff change readiness;
management change capability for both physicians and medical staff;
executive and leadership buy-in;
physician and medical staff productivity;
payer mix;
chart audit;
incentives;
auditing; and
follow-up.

22. The computer implemented system of claim 21 wherein the alignment phase providing means comprises one or more from a group consisting of
learning how and when to refer patients to other destinations;
understanding how to enhance patient flow through the emergency department so that medical staff resources can be used even more effectively than they already are;
feeling confident that low acuity patients will receive proper care when referred to appropriate destinations;
learning how to talk to patients in ways that create comfort for both the patient and the staff when making such referrals;
assuring themselves and their colleagues that emergency medical conditions are not overlooked;
feeling competent and comfortable addressing hyper-users and those who create conditions that sustain their frequent emergency department use;
feeling assured that the user's community backs their understanding of what is and what is not an emergency medical condition;
fully understanding the boundaries and implementing compliance requirements of the Emergency Medical Treatment and Active Labor Act;
feeling confident that they are fully supported by hospital administration through incentives and the like;
using an audit and quality checklist to assure that medical staff are successful in implementing the method; and
recovering a greater dollar percentage of billable services.

23. The computer implemented system of claim 21 wherein the application phase providing means comprises means for conducting a physician readiness workshop to restructure the strategies and thinking of the user's physicians.

24. The computer implemented system of claim 21 wherein the auditing phase providing means comprises means for utilizing an audit checklist to assure that successful implementation of the system of the present invention is accomplished.
